(19) United States
(12) Patent Application Publication
(10) Pub. No.: US 2026/0054911 A1
(43) Pub. Date: Feb. 26, 2026

(54) KEEP-FRESH CONTAINER

(71) Applicant: Julius Blum GmbH, Hoechst (AT)

(72) Inventors: Michael MANDLBURGER, Wolfurt (AT); Karolin Frei, Frastanz (AT); Christian Bertschler, Hard (AT)

(21) Appl. No.: 19/372,917

(22) Filed: Oct. 29, 2025

Related U.S. Application Data
(63) Continuation of application No. PCT/AT2024/060124, filed on Apr. 8, 2024.

(30) Foreign Application Priority Data
May 2, 2023 (AT) A 50329/2023

(51) Int. Cl. B65D 81/20; A23B 2/00; A23B 2/10; A23B 2/708

(52) U.S. Cl. CPC B65D 81/2038; A23B 2/001; A23B 2/103; A23B 2/708; B65D 81/2076

(57) ABSTRACT

A freshness container, in particular in the form of a vacuum drawer device, for food, includes at least one container base body and a container lid to be placed on the at least one container base body, and the container lid includes a control and/or regulating device and a sensor system. The sensor system is designed to determine a CO2 content, a temperature, and/or a proportion of, in particular volatile, organic compounds in an atmosphere arranged within the at least one container base body, and the control and/or regulating device is configured to adjust the CO2 content, the temperature, and/or the proportion of organic compounds in the atmosphere.

The present application is a continuation of International Application PCT/AT2024/060124 filed on Apr. 8, 2024. Thus, all of the subject matter of International Application PCT/AT2024/060124 is incorporated herein by reference.

### BACKGROUND OF THE INVENTION

The invention relates to a freshness container, in particular in the form of a negative pressure drawer device, for foods, comprising at least one container base body and a container lid which can be placed on the at least one container base body, wherein the container lid comprises a control and/or regulating device and at least one sensor system. Furthermore, the invention relates to a piece of furniture having such a freshness container, the use of a supply container for adjusting an atmosphere within a drawer, and a method for opening such a freshness container. Furthermore, the invention relates to a computer-implemented method for regulating an atmosphere of such a freshness container and a computer program product.

Such a freshness container is already known from document EP 3 740 099 A1, in which a container lid comprises an evacuation means in the form of a controller in conjunction with valves in order to generate a negative pressure in a drawer device.

Such a freshness container is also already known from document EP 4 073 442 A1, in which a monitoring method for a drawer interior is provided and a humidity sensor is present.

Such a freshness container is also already known from document EP 4 073 443 A1, in which a lifting device for a vacuum-sealed drawer having sealing fittings is used.

Such a freshness container is also already known from document EP 4 073 444 A, in which a multi-layer container lid having a printed circuit board and a dehumidification channel is used.

A disadvantage of the prior art is that food quality can only be adequately maintained for a limited period of time by the freshness containers, so that there is an ecological and economic need to be able to further reduce food waste.

### SUMMARY OF THE INVENTION

The objective technical problem of the present invention is therefore to provide a freshness container improved in relation to the prior art, in which the disadvantages of the prior art are at least partially eliminated, and which is distinguished in particular by enhanced functionality and/or by the capability of increased storage life of foods.

Therefore, according to the invention, at least one sensor system is designed to determine a CO2 content, a temperature, and/or a proportion of, in particular volatile, organic compounds of an atmosphere arranged within the at least one container base body and the at least one control and/or regulating device is configured to adjust the CO2 content, the temperature, and/or the proportion of organic compounds of the atmosphere.

This makes it possible for the first time—if necessary in addition to conventional measures such as dehumidification or pressure regulation—that the storage life of food is extendable to a significant extent.

Relevant influencing factors on food quality, food storage life, or the condition of food are the temporal environmental boundary conditions in the atmosphere adjacent to the food, which can be monitored by the freshness container via the sensor system and regulated via the control and/or regulating device. In this regard, it is ensured that criteria such as temperature and gas composition are regulated and, for example, moisture is reduced by binding or removal from foods and/or the atmosphere or cooling or heating is ensured.

In addition, food fermentation, chemical preservation, exposure to electromagnetic radiation—in particular UV or ionizing radiation, food fermentation, chemical preservation, mechanical energy—in particular in the form of pressure or shear forces, mechanical removal of microorganisms from foods can generally be carried out in order to influence a ripening process or to reduce contamination by microorganisms. However, UV treatment of food has only a minor influence on the storage life of foods due to the limited penetration depth, since only surface disinfection is possible.

Fruits, for example, have a metabolism, consume oxygen, and generate heat, CO2, water vapor, and aromatic compounds depending on the oxidation of carbohydrates, sugars, and acids in the tissue of the fruit. The relationship to storage life is very individual in this case, wherein this state of affairs can be taken into consideration by the freshness container. If necessary, control parameters of the degradation process, such as participating vitamins, acids, production of ethylene, decomposition of chlorophyll, etc., can be included, wherein the specific interaction with potential damage to the respective fruits—for example, storage diseases or core browning—can be taken into consideration.

For example, the use of physical or chemical propellants such as nitrogen, carbon dioxide, oxygen, argon, helium, or nitrous oxide can be used via the control and/or regulating device, which can positively (and possibly negatively) influence the metabolism of foods as a totality of all enzymatic reactions. The relationship can be based, for example, on the so-called Arrhenius equation, wherein, for example, the formation of ethylene can adversely influence the acceleration of the aging process.

Undesirable condensation can be efficiently counteracted, wherein a mere airtight seal is generally not sufficient to ensure particularly high food quality over a long period of time, since the interaction between the required air humidity and the necessary dehumidification—in particular depending on food types and an existing empty volume in the freshness container—is to be taken into consideration in order to inhibit a detrimental metabolism and/or to prevent undesired bacterial infestation and fungal growth.

The at least one sensor system can generally be designed as a common structural unit for a plurality of sensor signals to be determined and/or as spatially separate sensor units in order to provide information that can be used to reduce food waste due to improved storage conditions and food quality. Preferably, a sensor system is located directly above the respective container base body.

The control and/or regulating device can be used to optimize the storage conditions of foods located in the freshness container by adjustment, wherein, for example, an air exchange can be generated by valves of the container lid or via opening the container lid.

The freshness container is preferably in the form of a furniture drawer, wherein in general a drawer can comprise the freshness container and other furniture parts such as furniture flaps, boxes, or the like are conceivable.

For example, a milieu/an environment can be created for tomatoes, wherein the storage life of the tomatoes is longer, in the range of days or weeks, than if they were stored in a refrigerator and/or freely in a kitchen.

As stated at the outset, protection is also sought for a piece of furniture, comprising a furniture body and at least one such freshness container which is displaceable relative to the furniture body, wherein the freshness container is designed as a drawer.

For example, separated moisture can escape from the freshness container via slots or openings in the furniture body or can be discharged via a hose or container. To remove moisture, alternatively or additionally a gap or opening can be provided between drawer fronts and/or—preferably in a furniture body rear wall—in order to transfer moisture from an interior of the freshness container to an exterior space (analogous to a ventilation grille in refrigerators) via evaporation or vaporization. Preferably, moisture is evaporated from the furniture body through at least one ventilation slot on the furniture body and/or a recess in a drawer rear wall for a supply container.

As stated at the beginning, protection is also sought for the use of a supply container for adjusting an atmosphere within a drawer.

Supply containers—in particular CO2 containers—can be used according to the invention to regulate a ripening process of foods located in a drawer by inhibiting or augmenting a ripening process.

As stated at the outset, protection is also sought for a method for opening such a freshness container, wherein the following method steps are carried out:
an opening request of an operator of the freshness container is detected by a trigger mechanism, preferably via an overpressure movement
the container lid is raised relative to the at least one container base body via the trigger mechanism and the at least one container base body is displaced, in particular with a time delay, relative to a furniture body in the opening direction via the trigger mechanism and by a drive device.

A collision between the container lid and the at least one container base body can be prevented via the trigger mechanism—in particular by integrating a time delay—wherein a proper release of the container lid from the at least one container base body chronologically before the movement of the at least one container base body in the opening direction upon detection of an opening request by an operator can maintain the functionality of the freshness container over a long service life.

As stated at the outset, protection is also sought for a computer-implemented method for regulating an atmosphere of such a freshness container, wherein a control and/or regulating device records sensor data from at least one sensor system relating to a CO2 content, a temperature, and/or a proportion of organic compounds of an atmosphere arranged within a container base body and adjusts the atmosphere.

For example, depending on the desired mode of operation and/or the food located in the freshness container, a circuit can be initiated by the control and/or regulating device, in which a negative pressure or a vacuum (rough vacuum, fine vacuum, or high vacuum) is generated or maintained within the at least one container base body, physical variables are measured via the at least one sensor system, an air exchange or air circulation takes place, dehumidification is effectuated, a drying procedure is generated, and/or a drying procedure takes place.

Particularly preferably, a humidity and/or a pressure is detected via at least one sensor in a computer-aided manner and the humidity and/or the pressure in the atmosphere is adjusted.

As stated at the outset, protection is also sought for a computer program product comprising commands which, when executed by a computing unit, cause the computing unit to carry out such a computer-implemented method.

For example, the computing unit can be an integral part of the control and/or regulating device and/or can have a data connection to a storage unit or can be brought into such a connection, wherein sensor data-in particular having a history-are storable or stored on the storage unit.

A computer algorithm can, for example, be in the form of a two-point control for humidity regulation, wherein parameters such as target pressure, pump-out interval, hysteresis values for CO2, bVOC (biogenic volatile organic compound as special organic compounds), and humidity are modifiable via a configuration file.

According to an advantageous embodiment of the invention, an air humidity and/or a pressure of the atmosphere is detectable via the at least one sensor system and the control and/or regulating device is configured to adjust the air humidity and/or the pressure of the atmosphere. The atmosphere can be provided particularly favorably within the at least one container base body via the pressure and/or the air humidity in order to ensure advantageous conditions for individual foods.

Advantageously, at least one dehumidification unit for reducing the humidity of the atmosphere, preferably comprising a fan, and/or a pressure adjustment unit for adjusting the pressure of the atmosphere is provided.

For example, the pressure adjustment unit can comprise a pressure reducer having an adjustment wheel in order to be able to adjust the pressure present within the at least one container base body at a valve connected to the pressure adjustment unit.

It has proven to be advantageous for the pressure adjustment unit to comprise a vacuum pump and/or the dehumidification unit to comprise a diaphragm pump and/or a condensate pump.

According to an advantageous embodiment of the invention, the at least one sensor system and/or the control and/or regulating device is connected to at least one supply container, preferably a CO2 container, comprising at least one propellant, preferably CO2. Preferably, the at least one supply container is arranged horizontally or vertically and/or at least partially inside and/or outside the freshness container.

A gas composition within the at least one container base body can be controlled by the at least one supply container, wherein, for example, a ripening process can be slowed by adding CO2 to the atmosphere. For example, the at least one supply container can be arranged in the drawer or in a frame surrounding the at least one container base body, wherein an arrangement outside the drawer is preferred.

Particularly preferably, the at least one supply container is arranged upright or oriented in the vertical direction in order to prevent an outflow of contents, which can result in icing of valves, for example, due to heat extraction. In general, the at least one supply container can be connected in interaction with a radial fan.

An advantageous variant of the present invention is that at least one heat transfer unit, preferably a Peltier element, is provided for adjusting the temperature of the atmosphere. Preferably, the heat transfer unit is usable to separate moisture from the atmosphere.

A Peltier element can be used to set a desired temperature within the at least one container base body, wherein moisture can additionally be separated from the atmosphere. For example, a cooling element can be provided, via which moisture can be collected in a water bowl, wherein, for example, air humidity can condense on a Peltier element arranged above the container base body and can drip as condensate into a collecting bowl for removal.

It is particularly preferred that a ventilation device is provided, using which a composition of the atmosphere is changeable by air exchange with an exterior area of the freshness container.

For example, slots can be provided in the container lid and/or in the at least one container base body for an air inlet or an air outlet. Alternatively or additionally, air exchange can be established via valves or by opening the container lid. Air circulation can be achieved via a fan—preferably arranged above the at least one container base body—for mixing the atmosphere. If necessary, disinfectants can be used.

The ventilation device preferably comprises a, preferably replaceable, air filter and/or a, preferably removable, impeller. Particularly preferably, the air inlet and air outlet are as far apart from one another as possible—for example, arranged on opposite side walls of the container base body—and/or directed towards container base body side walls. Air can be distributed particularly effectively via a slot or using a large number of openings. Air can be exchanged via the ventilation device, for example by means of lifting magnets having seals and a radial fan having valves.

Preferably, the ventilation device comprises a water container for moisture extracted from the atmosphere.

In one exemplary embodiment of the present invention, the container lid and the at least one container base body are connected to one another in an essentially airtight manner by a sealing means in at least one operating position of the freshness container.

The sealing means can significantly reduce the entry of ambient air. The sealing means is preferably in the form of an elastic sealing lip—particularly preferably designed having a cross section as a flexible rectangle, circle, or D-profile. The material of the sealing means can consist of foam, gel material, or foam rubber, for example, wherein a low surface roughness is particularly preferred.

Particularly preferably, the container lid and/or the at least one container base body is designed as metallic.

A container base body or an area of the container lid facing toward the container base body which is made of metal can reduce the germ load of the freshness container.

According to a preferred exemplary embodiment of the invention, the freshness container comprises a drive device for moving the at least one container base body relative to a furniture body, wherein preferably the drive device is designed as an ejection device and/or is activatable in an overpressure position of the drive device.

This enhances operating convenience in the use of the freshness container. An opening request can be detected, for example, by exerting pressure on the drawer in an overpressure position, tactilely (for example by touch detection), and/or electronically (for example via radio actuation) by a trigger mechanism.

Preferably, the container lid comprises at least one, preferably two lifting motors, which are arranged diagonally on the container lid and/or are electric, for lifting the container lid relative to the at least one container base body.

For example, a linear drive can be used to ventilate the freshness container, wherein in the closed position the container lid can be pressed on via the seals. A vertical stroke by the lifting motor can be generated, for example, by a linear guide via elongated holes, spacers such as shims, or a link in conjunction with a toothed rack, wherein a motor stop can generally be detected via limit switches. A delay of the motor stop can be formed by software implementation and/or mechanically.

Furthermore, preferably a guide device is arranged on the container lid, by which the container lid can be lifted relative to the at least one container base body via the at least one lifting motor, wherein it is preferably provided that the guide device comprises an inclined plane and/or a groove in conjunction with a sliding block. The container lid can be opened in the use position in a vertical and/or horizontal direction, wherein it is generally conceivable to design the container lid to be pivotable relative to the at least one container base body for enhanced accessibility to stored goods. A vertical movement of the container lid can occur indirectly via a translational movement.

In a further embodiment, a trigger mechanism is provided for activating the drive device and/or the at least one lifting motor, using which the container lid can first be lifted and then the at least one container base body is movable in the opening direction, wherein the trigger mechanism preferably comprises a button and/or a proximity sensor. In this way, for example, the negative pressure within the freshness container can first be released and then the at least one container base body can be extended contactlessly relative to the container lid.

According to an advantageous embodiment of the invention, a plurality of container base bodies separated from one another via a separation device, preferably of varying dimensions, and exactly one container lid are provided for the plurality of container base bodies, wherein the control and/or regulating device is configured to individually adjust the atmospheres of the plurality of container base bodies.

If multiple container base bodies are present, varying types of food can be specifically handled via the atmosphere, wherein the empty volume of a specific container base body can also be reduced. The dimensions can generally differ in maximum width and/or depth.

It is particularly preferable that a plurality of valves be arranged on the container lid in connection with tubing of the container lid for detecting and/or changing the atmosphere.

The respective atmosphere of a plurality of container base bodies can be supplied to the at least one sensor system via the tubing and the atmospheres can be individually adjusted.

Advantageously, the at least one supply container is arranged at least partially between a container rear wall and a furniture body rear wall and/or in another furniture body and/or the furniture body rear wall has a recess for at least partially arranging the at least one supply container within the furniture body rear wall.

The available storage space can be increased by an arrangement behind the container rear wall or the container lid. A recess can prevent the need to replace or adjust standard dimensions for drawers. In addition, the tightness of the supply container can be enhanced by a supply container which is upright while in use.

If the at least one supply container is arranged in another, preferably adjacent, furniture body, for example, an existing infrastructure—preferably in conjunction with fittings—can be used efficiently by connecting it to the freshness container. The at least one supply container can generally be fixed to a static or a movable furniture part, for example to a bottle pull-out or waste pull-out.

### BRIEF DESCRIPTION OF THE DRAWINGS

Further details and advantages of the present invention will be explained in more detail below with reference to the drawings, in which:

FIGS. 1, 2 show a piece of furniture having a freshness container according to a preferred exemplary embodiment in a perspective view having an enlarged detail in the area of a supply container,

FIGS. 3, 4 show a freshness container according to a particularly preferred embodiment in a perspective view in the closed position and in a view from above,

FIGS. 5, 6 show the freshness container according to the exemplary embodiment of FIG. 3 in a side view having a detail illustration of a guide device and in a state of a dismantled container lid in a perspective view, and

FIG. 7 is a circuit diagram to illustrate a regulation of a freshness container by a control and/or regulating device.

### DETAILED DESCRIPTION OF THE INVENTION

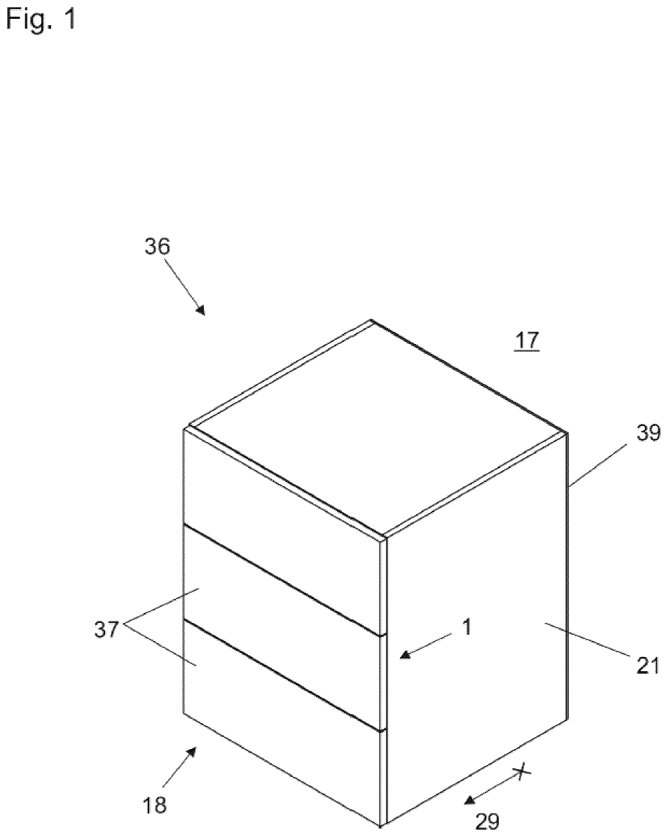

FIG. 1 shows a piece of furniture 36 comprising a furniture body 21 and a freshness container 1, displaceable relative to the furniture body 21, in the form of drawers 37. The number of drawers 37 and freshness containers 1 is generally arbitrary. For example, the lower drawer 37 can be a conventional drawer 37 and the upper drawer 37 can be a freshness container 1, wherein in this exemplary embodiment a panel for the electronics and infrastructure of the freshness container 1 is provided above the freshness container 1.

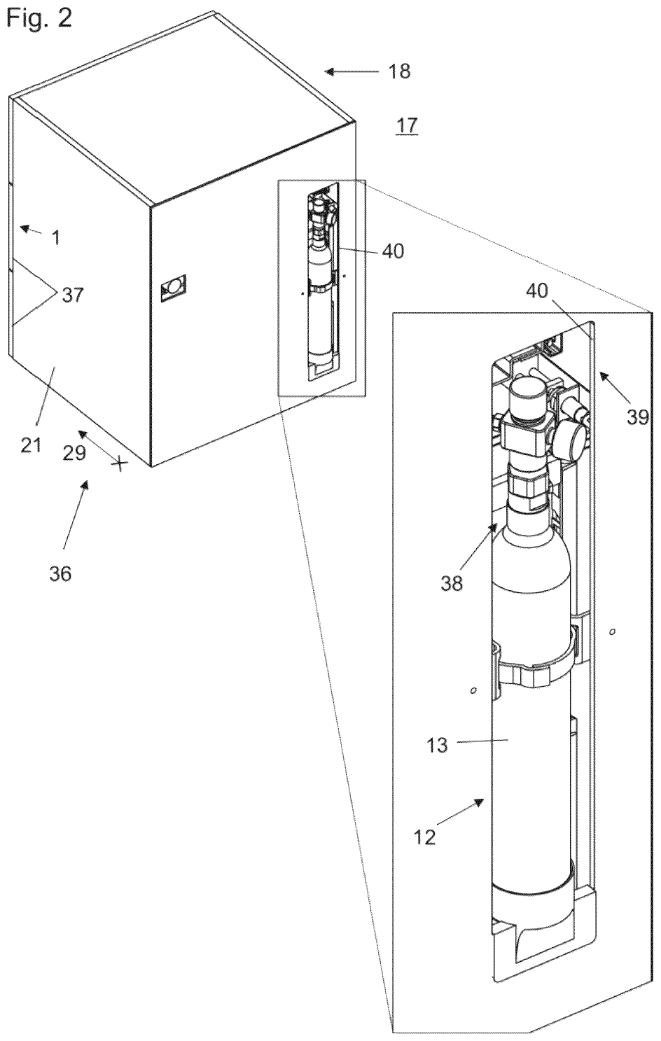

FIG. 2 shows the piece of furniture 36 with a viewing direction towards a furniture body rear wall 39, wherein a supply container 12 is used for adjusting an atmosphere 6 within a drawer 37, wherein the supply container 12 is arranged between a container rear wall 38 (as well as a container lid rear wall) and the furniture body rear wall 39.

The furniture body rear wall 39 comprises a recess 40 for the partial arrangement of the supply container 12 within the furniture body rear wall 39.

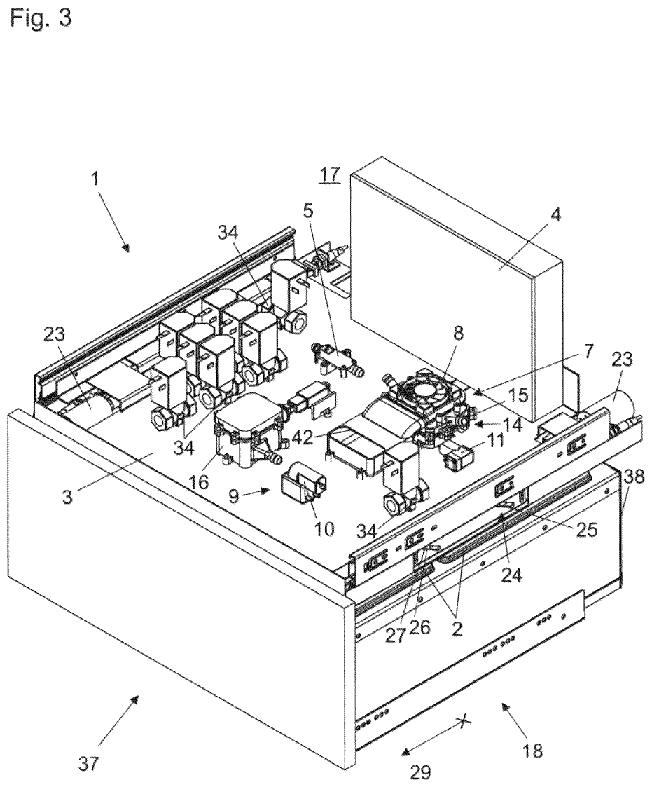

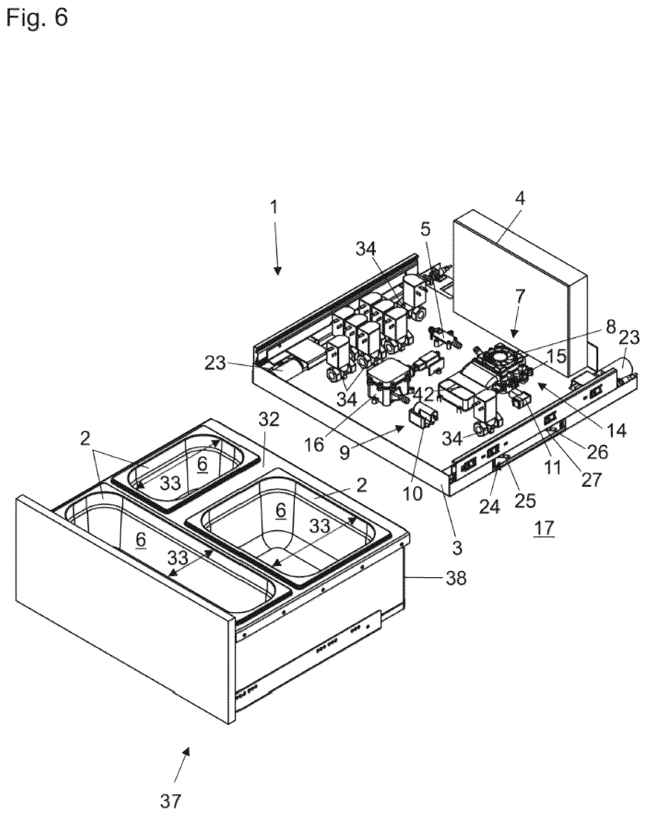

FIG. 3 shows the freshness container 1 in the form of a negative pressure drawer device for foods comprising three container base bodies 2 (concealed in the illustration—cf. FIG. 6), wherein the number of container base bodies 2 is generally arbitrary, and a container lid 3 that can be placed on the container base bodies 2.

The container lid 3 comprises a control and/or regulating device 4 and a sensor system 5, wherein the sensor system 5 is designed to determine a CO2 content, a temperature, and a proportion of organic compounds (such as volatile bVOC) of an atmosphere 6 arranged within the respective container base body 2. The atmosphere 6 can be analyzed separately for each container base body 2, although this is generally not obligatory. The control and/or regulating device 4 (the positioning and/or integration in component parts is generally arbitrary) is configured to adjust the CO2 content, the temperature, and the proportion of organic compounds in the atmosphere 6.

The sensor system 5 determines a humidity and a pressure of the atmosphere 6, wherein the control and/or regulating device 4 is configured to adjust the air humidity and the pressure of the atmosphere 6.

The freshness container 1 comprises a dehumidification unit 7 for reducing the air humidity of the atmosphere 6, wherein the dehumidification unit 7 has a fan 8, and a pressure adjustment unit 9 for adjusting the pressure of the atmosphere 6.

A liquid container 42 is arranged on the dehumidification unit 7, in which condensate from the atmosphere 6 can be collected.

The pressure adjustment unit 9 comprises a vacuum pump 10 (for generating a negative pressure within a container base body 2) and the dehumidification unit 7 comprises a diaphragm pump 11, which can alternatively or additionally be designed as a condensate pump.

The freshness container 1 has a heat transfer unit 14 comprising a Peltier element 15 for adjusting the temperature of the atmosphere 6, wherein the heat transfer unit 14 is usable for separating moisture from the atmosphere 6.

The Peltier element 15 is arranged below the dehumidification unit 7.

The freshness container 1 comprises a ventilation device 16, using which a composition of the atmosphere 6 is changeable by air exchange with an exterior area 17 of the freshness container 1. Alternatively or additionally, the ventilation device 16 can generate a circulation of the atmosphere 6 (recirculated air position).

Adjacent to the ventilation device 16, a linear actuator is connected, using which, depending on the position of the linear actuator, a line of the ventilation device 16 can be released so that air outside the freshness container 1 can be aspirated.

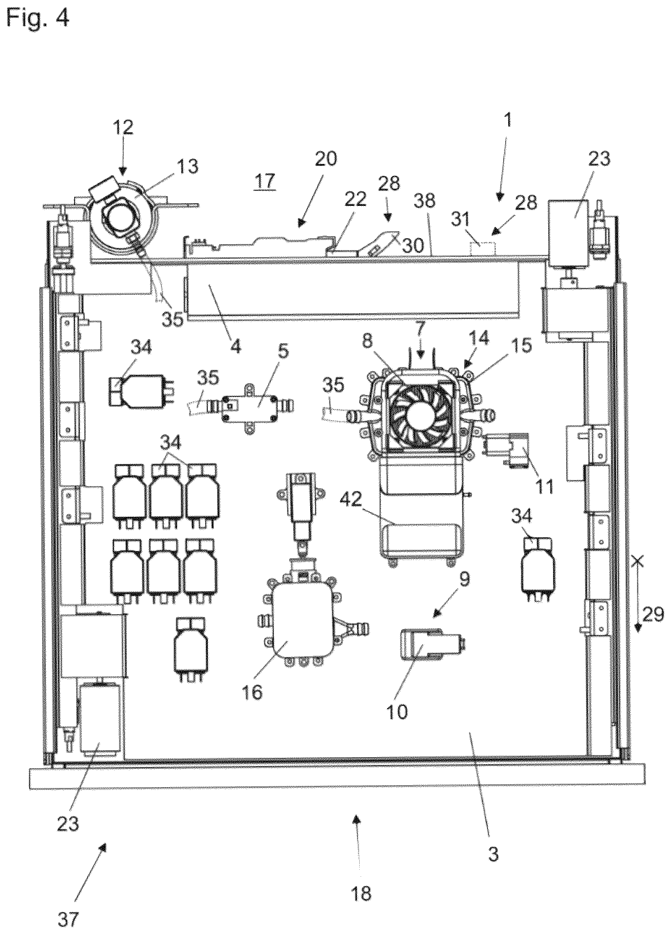

FIG. 4 shows that the control and/or regulating device 4 is arranged adjacent to the heat transfer unit 14, wherein the positioning is generally arbitrary and can, for example, also be arranged on the container base body 2, the drawer 37, or the furniture body 21.

The sensor system 5 and the control and/or regulating device 4 are connected to the supply container 12, which is designed as a CO2 container 13 having CO2 as a propellant. However, the supply container 12 can generally additionally or alternatively comprise other chemical or physical propellants.

The control and/or regulating device 4 can be designed, for example, as a computer unit or as a processor unit - optionally having a memory unit and/or an HMI.

In the usage position of the freshness container 1, the supply container 12 is arranged upright and outside the freshness container 1.

The freshness container 1 comprises a drive device 20 for moving the container base body 2 relative to the furniture body 21, wherein the drive device 20 is designed as an ejection device 22 and is activatable in an overpressure position of the drawer 37 or the drive device 20.

The container lid 3 has two electrical lifting motors 23 arranged diagonally on the container lid 3 for lifting the container lid 3 relative to the container base bodies 2, wherein a lifting movement in the vertical direction is generated by a translational movement in the opening direction 29.

The freshness container 1 has a trigger mechanism 28 for activating the drive device 20 and the lifting motors 23, using which first the container lid 3 is liftable and then the container base bodies 2 are movable in the opening direction 29.

In this exemplary embodiment, a trigger mechanism 28 is arranged on the drive device 20 and a trigger mechanism 28 is arranged on the freshness container 1, wherein one trigger mechanism is designed in the form of a button 30 and one trigger mechanism is designed as a proximity sensor 31.

An exemplary method for opening the freshness container 1 can be carried out as follows: An opening request of an operator of the freshness container 1 is detected by the trigger mechanism 28 by means of an overpressure movement on the drawer 37, the container lid 3 is lifted relative to the container base bodies 2 via the trigger mechanism 28, and the container base bodies 2 are displaced with a time delay via the trigger mechanism 28 and by the drive device 20 relative to the furniture body 21 in the opening direction 29.

In general, however, a lifting movement of the container lid 3 occurring in the course of the opening movement of the container base bodies 2 is also possible, wherein a release procedure of the container lid 3 occurs simultaneously with or in the course of the linear movement of the container base bodies 2 in the opening direction 29.

A plurality of valves 34 is arranged on the container lid 3 in connection with tubing 35 (schematically indicated in dotted lines) of the container lid 3 for detecting and changing the atmosphere 6.

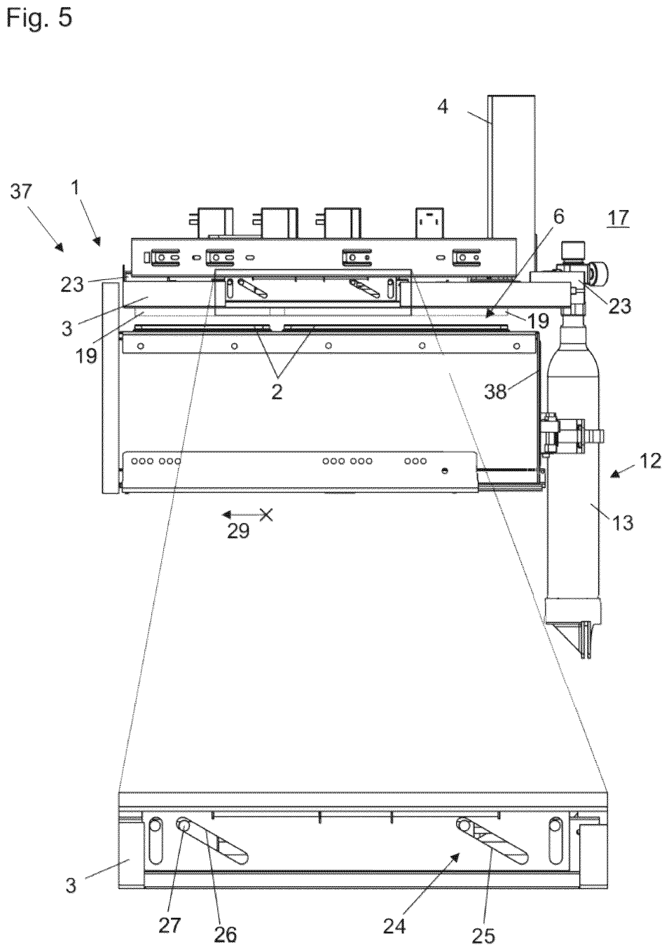

FIG. 5 shows that a guide device 24 is arranged on the container lid 3, by means of which the container lid 3 is liftable relative to the container base bodies 2 via the lifting motors 23. The guide device 24 comprises an inclined plane 25 which is designed as a groove 26 and in which a sliding block 27 is arranged.

The container lid 3 and the container base body 2 are connected to one another in an airtight manner in the operating position 18 of the closed state (see FIG. 3) of the freshness container 1 by sealing means 19, wherein the sealing means 19 are indicated schematically in dotted lines.

In FIG. 6 it can be seen that the freshness container 1 comprises three container base bodies 2 separated from one another via a separation device 32, wherein the shape, number, and positioning of the container base bodies 2 are generally arbitrary.

The container base bodies 2 have different length and width dimensions as varying dimensions 33. For the container base bodies 2, exactly one container lid 3 is provided for the plurality of container base bodies 2, wherein the control and/or regulating device 4 is programmed to individually adjust the atmospheres 6 of the plurality of container base bodies 2.

The container base bodies 2 are designed as metallic. The container lid 3 is made partially of metal and partially of wood, wherein it is preferred to make the container lid 3 metallic in some areas—in the closed position in the area of the container base body 2.

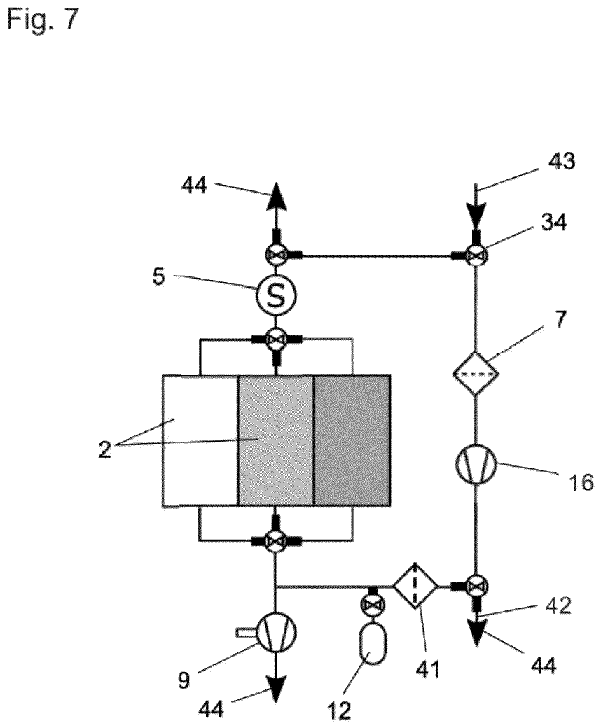

FIG. 7 visualizes components of the freshness container 1 in the form of a circuit diagram. A plurality of valves 34 are connected to the three container base bodies 2, which in turn are connected to an air inlet 43 and (in this embodiment) three air outlets 44. A filter 41 is provided between the ventilation device 16 and the pressure adjustment device, wherein, for example, the adjacent supply container 12 can be dispensed with.

A liquid container 42 is connected between a valve 34 and an air outlet 44, via which condensate bound from the atmosphere can be removed—but is generally not absolutely necessary.

In general, moisture can be removed via pipes or ventilated. For example, liquid can be transported away from the freshness container 1 or an interior of the freshness container 1 by evaporation in a collecting tray at the fan 8 and/or the Peltier element 15 from the furniture body 21 via ventilation slots, through tubing 35 and/or through the liquid container 42 in the form of a collecting container for condensate.

A computer-implemented method for regulating the atmosphere 6 of the freshness container 1 can be explained as follows: The control and/or regulating device 4 determines sensor data of the sensor system 5 with regard to the existing CO2 content, the temperature or the proportion of organic compounds within the atmosphere 6 of the container base body 2 or the atmospheres 6 of the container base body 2 and adjusts the atmosphere(s) 6 according to predefined or desired atmosphere properties/compositions.

For this purpose, a computer program product can be provided as an algorithm, which comprises instructions which, when executed by a computing unit, cause the computing unit to carry out the method for controlling the atmosphere 6. The computer program product can be stored on a volatile or non-volatile storage medium or transmitted via a data signal.

1. A freshness container, in particular in the form of a vacuum drawer device, for food, comprising:
at least one container base body; and
a container lid to be placed on the at least one container base body, the container lid including a control and/or regulating device and at least one sensor system,
wherein the at least one sensor system is designed to determine a CO2 content, a temperature, and/or a proportion of, in particular volatile, organic compounds in an atmosphere arranged within the at least one container base body, and the at least one control and/or regulating device is configured to adjust the CO2 content, the temperature and/or the proportion of organic compounds in the atmosphere.

2. The freshness container according to claim 1, wherein an air humidity and/or a pressure of the atmosphere is detectable via the at least one sensor system and the control and/or regulating device is configured to adjust the air humidity and/or the pressure of the atmosphere.

3. The freshness container according to claim 1, wherein at least one dehumidification unit for reducing the air humidity of the atmosphere, preferably comprising a fan, and/or a pressure adjustment unit for adjusting the pressure of the atmosphere is provided.

4. The freshness container according to claim 3, wherein the pressure adjustment unit comprises a vacuum pump and/or the dehumidification unit comprises a diaphragm pump and/or a condensate pump.

5. The freshness container according to claim 1, wherein the at least one sensor system and/or the control and/or regulating device is connected to at least one supply container, preferably a CO2 container, comprising at least one propellant, preferably CO2, wherein it is preferably provided that the at least one supply container is arranged horizontally or vertically and/or at least partially inside and/or outside the freshness container.

6. The freshness container according to claim 1, wherein at least one heat transfer unit, preferably a Peltier element, is provided for adjusting the temperature of the atmosphere, wherein it is preferably provided that the heat transfer unit is usable for separating moisture from the atmosphere.

7. The freshness container according to claim 1, wherein a ventilation device is provided, using which a composition of the atmosphere is changeable by air exchange with an exterior area of the freshness container.

8. The freshness container according to claim 1, wherein the container lid and the at least one container base body are connected to one another in a substantially airtight manner by a sealing means in at least one operating position of the freshness container.

9. The freshness container according to claim 1, wherein the container lid and/or the at least one container base body is metallic.

10. The freshness container according to claim 1, further comprising a drive device for moving the at least one container base body relative to a furniture body, wherein it is preferably provided that the drive device is designed as an ejection device and/or is activatable in an overpressure position of the drive device.

11. The freshness container according to claim 1, wherein the container lid comprises at least one, preferably two lifting motors, which are diagonally arranged on the container lid and/or are electric, for lifting the container lid relative to the at least one container base body.

12. The freshness container according to claim 11, further comprising a guide device arranged on the container lid, by means of which the container lid is liftable relative to the at least one container base body via the at least one lifting motor, wherein it is preferably provided that the guide device comprises an inclined plane and/or a groove in conjunction with a sliding block.

13. The freshness container according to claim 10, further comprising a trigger mechanism for activating the drive device and/or the at least one lifting motor, using which first the container lid is liftable and then the at least one container base body is movable in the opening direction, wherein the trigger mechanism preferably comprises a button and/or a proximity sensor.

14. The freshness container according to claim 1, further comprising a plurality of container base bodies separated from one another by a separating device, preferably of varying dimensions, and precisely one container lid for the plurality of container base bodies, wherein the control and/or regulating device is configured to individually adjust the atmospheres of the plurality of container base bodies.

15. The freshness container according to claim 1, further comprising a plurality of valves arranged on the container lid in connection with tubing of the container lid for detecting and/or changing the atmosphere.

16. A piece of furniture comprising:
a furniture body; and
the freshness container according to claim 1 displaceable relative to the furniture body, wherein the freshness container is a drawer.

17. The piece of furniture according to claim 16, wherein the at least one supply container is arranged at least partially between a container rear wall and a furniture body rear wall and/or in a further furniture body and/or the furniture body rear wall has a recess for at least partially arranging the at least one supply container within the furniture body rear wall.

18. A use of a supply container for adjusting an atmosphere within a drawer.

19. A method for opening a freshness container according to claim 1, comprising:
detecting an opening request of an operator of the freshness container by a trigger mechanism, preferably via an overpressure movement,
raising the container lid relative to the at least one container base body via the trigger mechanism and displacing the at least one container base body, in particular with a time delay, relative to a furniture body in the opening direction via the trigger mechanism and by a drive device.

20. A computer-implemented method for regulating an atmosphere of a freshness container according to claim 1, wherein a control and/or regulating device detects sensor data from at least one sensor system relating to a CO2 content, a temperature, and/or a proportion of organic compounds in an atmosphere arranged within a container base body and adjusts the atmosphere.

21. A computer program product comprising instructions which, when executed by a computing unit, cause the computing unit to carry out the method according to claim 20.
